(19) United States
(12) Patent Application Publication
(10) Pub. No.: US 2024/0387123 A1
(43) Pub. Date: Nov. 21, 2024

(54) TRANSVERSE VACUUM CIRCUIT BREAKER

(71) Applicant: Schneider Electric (Xiamen) Switchgear Equipment Co., Ltd., Xiamen (CN)

(72) Inventors: Qiliang Wang, Shanghai (CN); Florent Berardengo, Grenoble (FR); Hongbing Liao, Shanghai (CN); Chia-Yin Wu, Shanghai (CN)

(73) Assignee: Schneider Electric (Xiamen) Switchgear Equipment Co., Ltd., Xiamen, FJ (CN)

(21) Appl. No.: 18/650,287

(22) Filed: Apr. 30, 2024

(30) Foreign Application Priority Data
May 15, 2023 (CN) 202310545006.6

(51) Int. Cl. H01H 33/42; H01H 33/53

(52) U.S. Cl. CPC H01H 33/42; H01H 33/53

(57) ABSTRACT

A transverse vacuum circuit breaker, a plurality of pole assemblies are mounted on the frame assembly, and the pole rotating shaft is capable of being rotatably mounted inside the frame assembly; one end of the pole actuating assembly is connected to the pole rotating shaft; the other end of the pole actuating assembly acts on the pole assembly; the mechanism main shaft is capable of rotating between a first position and a second position, and a rotation of the mechanism main shaft is capable of driving a rotation of the pole rotating shaft; upon the mechanism main shaft rotating to the first position, the pole actuating assembly allows the plurality of pole assemblies in a disconnected state; upon the mechanism main shaft rotating to the second position, the pole actuating assembly allows the plurality of pole assemblies in a closed state.

### TECHNICAL FIELD

The present disclosure relates to a new type of transverse vacuum circuit breaker, which includes a frame with simple design, a stable transmission chain, a flexible pole mounting direction, and a visual stroke, and an overtravel monitoring structure.

### BACKGROUND

In the existing art, the transverse vacuum circuit breaker usually adopts a push/pull motion system to achieve the closing and opening operation of the transverse vacuum circuit breaker, which leads to a large number of components and thus low cost efficiency.

In addition, in the existing art, the whole frame of the transverse circuit breaker is made by welding process, and welding deformation always exists, which will reduce the processing consistency.

Finally, in the existing art, the connecting rod system between the transverse vacuum circuit breaker pole and the transmission chain has no visible contact stroke structure, so it is not easy to monitor the change of contact stroke, which is not conducive to maintenance or inspection.

### SUMMARY

In order to solve one or more defects in the existing art, an aspect of the present disclosure provides a transverse vacuum circuit breaker, the transverse vacuum circuit breaker includes a frame assembly, a pole assembly, a mechanism support plate, a mechanism main shaft, a ball joint connecting rod, a pole rotating shaft and a pole actuating assembly.

The mechanism support plate is connected to the frame assembly and the mechanism main shaft is capable of being rotatably mounted on the mechanism support plate.

A plurality of pole assemblies are mounted on the frame assembly, and the pole rotating shaft is capable of being rotatably mounted inside the frame assembly.

One end of the pole actuating assembly is connected to the pole rotating shaft.

The other end of the pole actuating assembly acts on the pole assembly.

The ball joint connecting rod is connected between the mechanism main shaft and the pole rotating shaft.

The mechanism main shaft is capable of rotating between a first position and a second position, and a rotation of the mechanism main shaft is capable of driving a rotation of the pole rotating shaft through the ball joint connecting rod, and the rotation of the pole rotating shaft drives a movement of the pole actuating assembly.

Upon the mechanism main shaft rotating to the first position, the pole actuating assembly allows the plurality of pole assemblies in a disconnected state.

Upon the mechanism main shaft rotating to the second position, the pole actuating assembly allows the plurality of pole assemblies in a closed state.

According to the above aspect of the present disclosure, the frame assembly includes a top plate.

The top plate is provided with a plurality of top plate through holes spaced at equal intervals from each other along a length direction of the top plate.

The top plate is provided with a first direction top plate mounting hole and a second direction top plate mounting hole corresponding to each of the plurality of top plate through holes.

The pole assembly is capable of being mounted on the top plate in a first direction through the first direction top plate mounting hole.

The pole assembly is capable of being mounted on the top plate in a second direction opposite to the first direction through the second direction top plate mounting hole.

According to the above aspects of the present disclosure, the frame assembly further includes a base plate and a side plate.

The side plate is connected to one end of the top plate and one end of the base plate through a threaded connection mode or a riveting connection mode.

The mechanism support plate is connected to the other end of the top plate and the other end of the base plate through a threaded connection mode or a riveting connection mode.

According to the above aspects of the present disclosure, the frame assembly further includes a plurality of intermediate support plates.

The plurality of intermediate support plates are spaced apart from each other along a length direction of the top plate and the base plate and are connected between the top plate and the base plate by a threaded connection mode or a riveting connection mode.

According to the above aspects of the present disclosure, the frame assembly further includes a plurality of frame support pins.

The plurality of frame support pins are connected between the top plate and the base plate through a threaded connection mode or a riveting connection mode.

According to the above aspects of the present disclosure, the side plate is a component made of a metal or plastic material.

The side plate includes a side plate bottom and a side plate wall bent relative to the side plate bottom;

The side plate wall is provided with a side plate wall mounting hole for riveting or threaded connection;

The side plate bottom is provided with a side plate supporting hole for supporting the pole rotating shaft.

According to the above aspects of the present disclosure, each of the plurality of intermediate support plates is a component made of a metal or plastic material.

Each of the plurality of intermediate support plates includes an intermediate support plate bottom and an intermediate support plate wall bent relative to the intermediate support plate bottom.

Each of the plurality of intermediate support plates is provided with an intermediate support plate wall mounting hole for riveting or threaded connection.

The intermediate support plate bottom is provided with an intermediate support plate supporting hole for supporting the pole rotating shaft.

The intermediate support plate supporting hole includes an opening on the intermediate support plate wall.

According to the above aspects of the present disclosure, the top plate is a sheet metal component made of a metal material.

The top plate includes a top plate bottom and a top plate wall bent relative to the top plate bottom.

The top plate bottom and the top plate wall are provided with top plate mounting holes for riveting or threaded connection.

The top plate bottom is provided with the plurality of top plate through holes, the first direction top plate mounting hole and the second direction top plate mounting hole.

According to the above aspects of the present disclosure, the base plate is a sheet metal component made of a metal material.

The base plate includes a base plate bottom and a base plate wall bent relative to the base plate bottom.

The base plate bottom and the base plate wall bent are provided with base plate mounting holes for riveting or threaded connection.

According to the above aspects of the present disclosure, the mechanism support plate is a sheet metal component made of a metal material.

The mechanism support plate includes a support plate bottom and a support plate wall bent relative to the support plate bottom.

The support plate wall is respectively connected to the base plate wall and the top plate wall through a threaded connection mode or a riveting connection mode.

The support plate bottom is provided with a support plate supporting hole for supporting the pole rotating shaft.

According to the above aspects of the present disclosure, the side plate wall is respectively connected to the top plate bottom, the top plate wall, the base plate bottom and the base plate wall.

The intermediate support plate wall is respectively connected to the top plate bottom, the top plate wall, the base plate bottom and the base plate wall.

According to the above aspects of the present disclosure, the pole rotating shaft includes a pole rotating shaft body, a plurality of pole rotating shaft crank arms, a spring support block arranged on a corresponding one of the plurality of pole rotating shaft crank arms, and a pole rotating shaft driving crank arm.

The plurality of pole rotating shaft crank arms are arranged on the pole rotating shaft body at equal intervals along a length direction of the pole rotating shaft body and arranged in one-to-one correspondence with the plurality of pole assemblies.

The pole rotating shaft driving crank arm is arranged at one end of the pole rotating shaft body.

One end of the pole rotating shaft body is capable of being rotatably fitted in the support plate supporting hole.

The other end of the pole rotating shaft body is capable of being rotatably fitted in the side plate supporting hole.

The spring support block is provided with a spring support block plane and a spring support block through hole.

The spring support block through hole penetrates through the spring support block and the spring support block plane.

According to the above aspects of the present disclosure, the pole rotating shaft body is an elongated solid cylinder or an elongated tubular cylinder.

According to the above aspects of the present disclosure, the ball joint connecting rod includes two ball joints, a threaded connecting rod and a fastening screw.

The ball joints are respectively connected to two ends of the threaded connecting rod through threads and fastened in place through the fastening screw.

The pole rotating shaft driving crank arm is connected to one of the ball joints through a connection pin.

The mechanism main shaft is connected to the other one of the ball joints through a connection pin.

An axis of the connection pin fitted in one of the ball joints is perpendicular to an axis of the connection pin fitted in the other one of the ball joints.

According to the above aspects of the present disclosure, the mechanism main shaft includes a mechanism main shaft body and a mechanism main shaft crank arm arranged on the mechanism main shaft body.

The mechanism main shaft crank arm is connected to the other one of the ball joints through a connection pin.

Two ends of the mechanism main shaft body are capable of being rotatably connected to support plate connection pieces arranged on the support plate wall.

According to the above aspects of the present disclosure, the pole actuating assembly includes a threaded pin, a sleeve, a contact spring, an adjusting nut and a fastening screw.

One end of the threaded pin passes through the spring support block through hole.

The other end of the threaded pin passes through a corresponding one of the plurality of top plate through holes and enters an interior of the pole assembly and acts on the pole assembly.

One end of the sleeve passes through the spring support block through hole.

The sleeve is sleeved on the threaded pin and is capable of being adjusted to move along the threaded pin through threaded fit between the sleeve and the threaded pin.

One end of the contact spring abuts against a sleeve flange of the sleeve.

The sleeve flange is capable of passing through a corresponding one of the plurality of top plate through holes.

The other end of the contact spring abuts against the spring support block plane of the spring support block.

The adjusting nut is fitted on one end of the sleeve and abuts against the spring support block, and a position of the sleeve is capable of being adjusted through the adjusting nut, thus achieving an adjustment of a contact stroke.

A sleeve shoulder is arranged on one end of the sleeve, and a movement of the adjusting nut on one end of the sleeve is limited by the sleeve shoulder.

The fastening screw is fitted on one end of the threaded pin by screw threads and is capable of abutting against the adjusting nut, and the fastening screw is tightened to fix the adjusting nut.

According to the above aspects of the present disclosure, upon the transverse vacuum circuit breaker being in the disconnection state, a trigger mechanism of the transverse vacuum circuit breaker drives the mechanism main shaft to rotate from the first position to the second position, and the mechanism main shaft crank arm of the mechanism main shaft drives the ball joint connecting rod to move through the connection pin, and a movement of the ball joint connecting rod drives the pole rotating shaft crank arm of the pole rotating shaft to rotate through the connection pin and the pole rotating shaft driving crank arm, a rotation of the pole rotating shaft crank arm allows the spring support block to press the contact spring to move upwards, and an upward movement of the contact spring drives the sleeve to move through the sleeve flange acting on the sleeve, and a movement of the sleeve drives the threaded pin to move in the pole assembly, and a movement of the threaded pin acts on the pole assembly, so that the transverse vacuum circuit breaker is in the closed state.

In the closed state, a gap exists between the adjusting nut and the spring support block, and the gap is capable of being observed through a space between the top plate and the base plate.

The transverse vacuum circuit breaker according to the present disclosure has a frame assembly with simple design, the top plate, the base plate, the side plate and the intermediate support plate in the frame assembly are all formed by sheet metal components and connected together by riveting connection mode or threaded connection mode, thereby avoiding the defect that the whole frame connected by welding is easy to deform and reducing the assembly time.

By arranging the first direction top plate mounting hole and the second direction top plate mounting hole on the top plate corresponding to each of the plurality of top plate through holes, the pole assembly is capable of being mounted on the top plate in a first direction through the first direction top plate mounting hole and in a second direction opposite to the first direction through the second direction top plate mounting hole, thus achieving a flexible pole assembly mounting direction.

The transverse vacuum circuit breaker according to the present disclosure connects the pole rotating shaft and the mechanism main shaft together through the ball joint connecting rod to form a new type and simple connecting rod mechanism, thereby reducing moving components as much as possible, and further reducing the cost and assembly time. Because the push/pull motion system is avoided to achieve the closing and opening operations of the transverse vacuum circuit breaker, the transverse vacuum circuit breaker according to the present disclosure can achieve the stable synchronization of the pole assemblies.

So far, in order that the detailed description of the present disclosure herein can be better understood and the contribution of the present disclosure to the existing art can be better recognized, the present disclosure has outlined the contents of the present disclosure quite broadly. Of course, embodiments of the present disclosure will be described below and will form the subject of the appended claims.

Likewise, those skilled in the art will recognize that the concept on which the present disclosure is based can be easily used as a basis for designing other structures, methods and systems for carrying out the several purposes of the present disclosure. Therefore, it is important that the appended claims should be regarded as including such equivalent structures as long as they do not exceed the spirit and scope of the present disclosure.

### BRIEF DESCRIPTION OF DRAWINGS

Those skilled in the art will have a better understanding of the present disclosure through the following drawings, and the advantages of the present disclosure can be more clearly reflected. The drawings described here are only for illustrative purposes of selected embodiments, not all possible embodiments, and are not intended to limit the scope of the present disclosure.

FIG. 1 shows a schematic perspective view of a transverse vacuum circuit breaker according to the present disclosure, in which the transverse vacuum circuit breaker is in a disconnection state;

FIG. 2 shows a schematic perspective view of a transverse vacuum circuit breaker according to the present disclosure, in which the transverse vacuum circuit breaker is in a closed state;

FIG. 3 shows a schematic perspective view of a top plate according to the present disclosure;

FIG. 4 shows a schematic perspective view of a base plate according to the present disclosure;

FIG. 5 shows a schematic perspective view of a side plate according to the present disclosure;

FIG. 6 shows a schematic perspective view of an intermediate support plate according to the present disclosure;

FIGS. 7 and 8 show schematic perspective views of a mechanism support plate according to the present disclosure;

FIGS. 9 and 10 show schematic perspective views of a pole rotating shaft according to the present disclosure;

FIG. 11 shows a perspective schematic view of the connection between a pole rotating shaft and a ball joint connecting rod according to the present disclosure;

FIG. 12 shows a schematic perspective view of a mechanism main shaft connected with a pole rotating shaft through a ball joint connecting rod according to the present disclosure;

FIG. 13 shows an assembly schematic diagram of a pole actuating assembly and a spring support block according to the present disclosure;

FIG. 14 shows a perspective schematic view of a sleeve of a pole actuating assembly according to the present disclosure;

FIG. 15 shows an assembly schematic diagram of a sleeve and an adjusting nut of a pole actuating assembly according to the present disclosure;

FIG. 16 shows an assembly schematic diagram of a sleeve, an adjusting nut and a spring support block of a pole actuating assembly according to the present disclosure;

FIG. 17 shows an assembly schematic diagram of a threaded pin, a sleeve, an adjusting nut and a spring support block of a pole actuating assembly according to the present disclosure;

FIG. 18 shows an assembly schematic diagram of a contact spring, a fastening screw, a threaded pin, a sleeve, an adjusting nut and a spring support block of a pole actuating assembly according to the present disclosure;

FIG. 19 is a side view showing a transverse vacuum circuit breaker according to the present disclosure in a disconnection state;

FIG. 20 is a side view showing a transverse vacuum circuit breaker according to the present disclosure in a closed state;

FIG. 21 shows a gap G between an adjusting nut and a spring support block in the closed state.

### DETAILED DESCRIPTION

Hereinafter, specific embodiments according to the present disclosure will be described in detail with reference to the accompanying drawings.

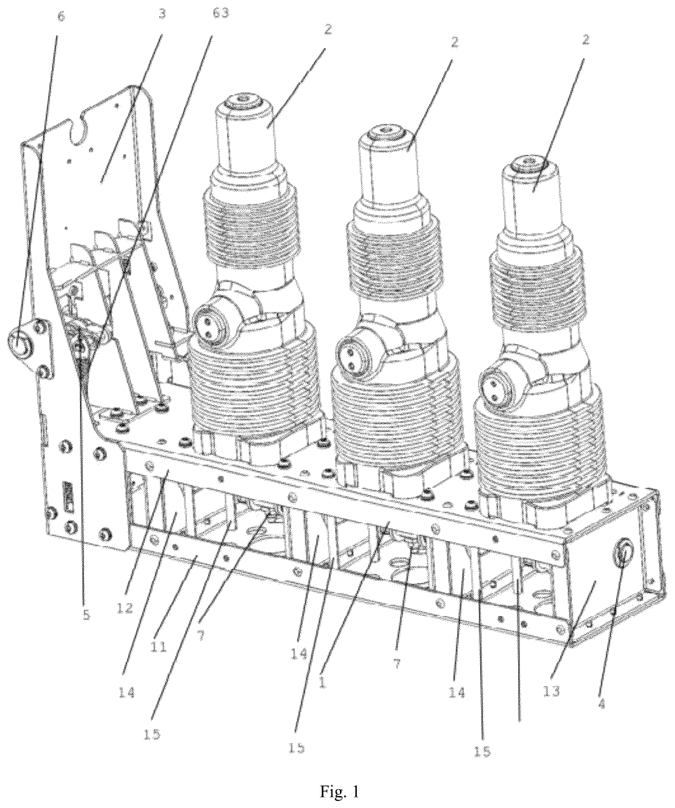

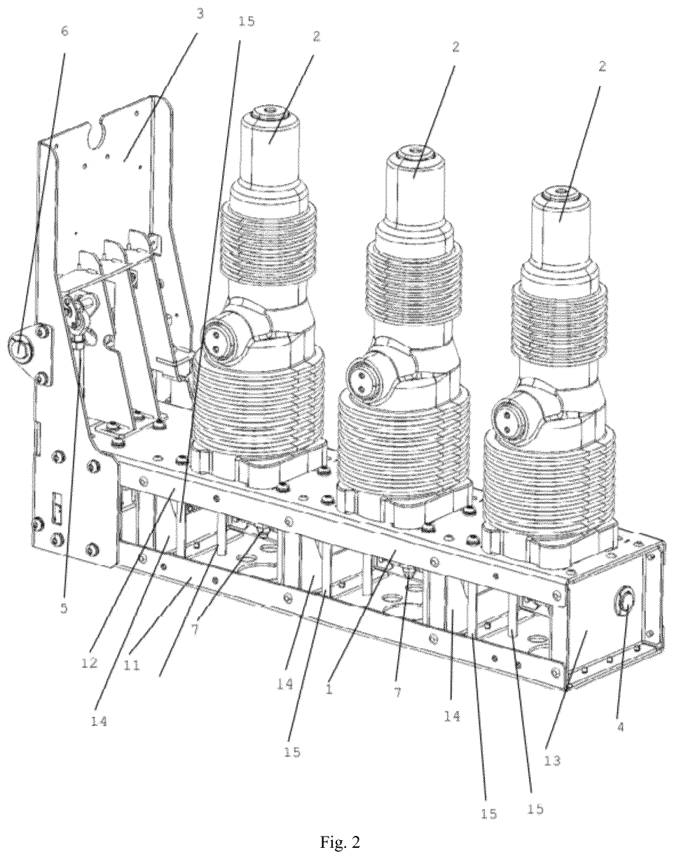

As illustrated by FIG. 1 and FIG. 2, according to an embodiment of the present disclosure, a transverse vacuum circuit breaker is provided, which includes a frame assembly 1, a pole assembly 2, a mechanism support plate 3, a pole rotating shaft 4, a ball joint connecting rod 5, a mechanism main shaft 6 and a pole actuating assembly 7.

The mechanism support plate 3 is connected to the frame assembly 1 and the mechanism main shaft 6 is capable of being rotatably mounted on the mechanism support plate 3.

A plurality of pole assemblies 2 are mounted on the frame assembly 1, and the pole rotating shaft 4 is capable of being rotatably mounted inside the frame assembly 1.

In FIG. 1 and FIG. 2, three pole assemblies 2 are shown.

One end of the pole actuating assembly 7 is connected to the pole rotating shaft 4. The other end of the pole actuating assembly 7 acts on the pole assembly 2.

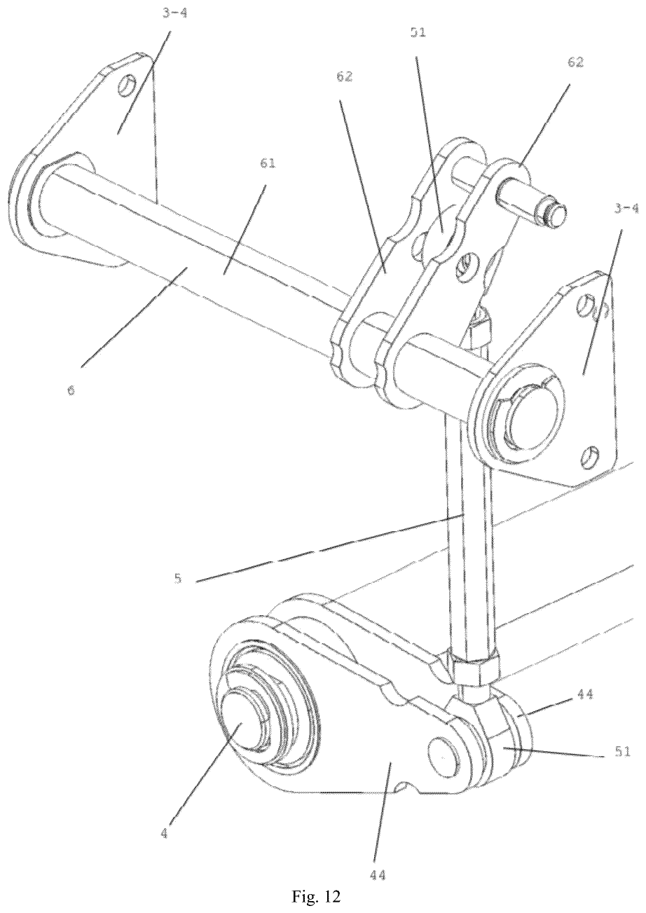

As illustrated by FIG. 12, the ball joint connecting rod 5 is connected between the mechanism main shaft 6 and the pole rotating shaft 4.

The mechanism main shaft 6 is capable of rotating between a first position and a second position, and a rotation of the mechanism main shaft 6 is capable of driving a rotation of the pole rotating shaft 4 through the ball joint connecting rod 5, and the rotation of the pole rotating shaft 4 drives a movement of the pole actuating assembly 7.

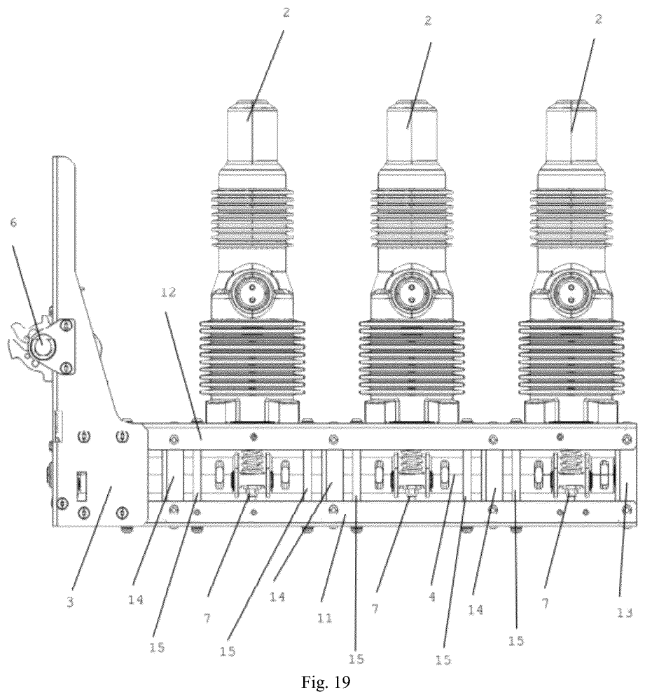

As illustrated by FIG. 19, upon the mechanism main shaft 6 rotating to the first position, the pole actuating assembly 7 allows the plurality of pole assemblies 2 in a disconnected state.

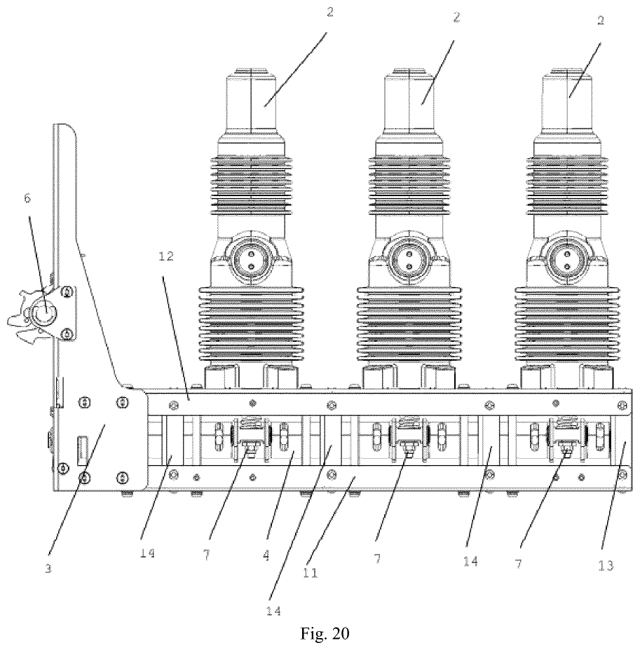

As illustrated by FIG. 20, upon the mechanism main shaft 6 rotating to the second position, the pole actuating assembly 7 allows the plurality of pole assemblies 2 in a closed state.

According to the above embodiment of the present disclosure, as illustrated by FIG. 1 and FIG. 2, the frame assembly 1 includes a top plate 12.

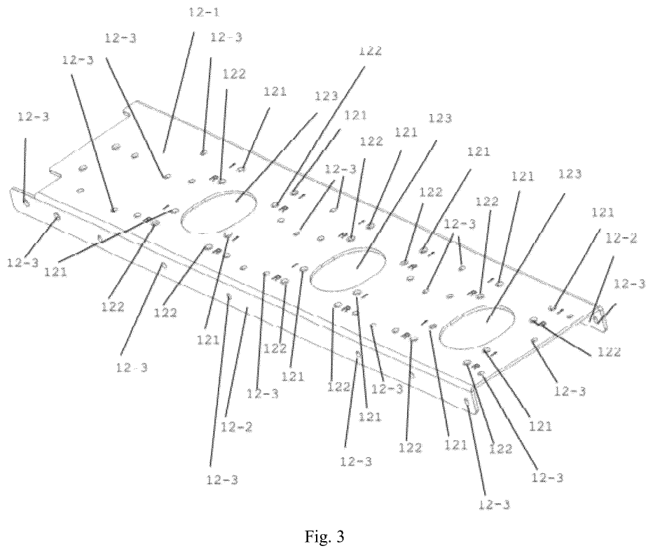

The top plate 12 is provided with a plurality of top plate through holes 123 spaced at equal intervals from each other along a length direction of the top plate 12 (see FIG. 3, in which three top plate through holes 123 are shown to correspond to three pole assemblies 2, respectively).

The top plate 12 is provided with a first direction top plate mounting hole 121 and a second direction top plate mounting hole 122 corresponding to each of the plurality of top plate through holes 123.

The pole assembly 2 is capable of being mounted on the top plate 12 in a first direction through the first direction top plate mounting hole 121.

As illustrated by FIG. 1 and FIG. 2, the pole assembly 2 is capable of being mounted on the top plate 12 in a second direction opposite to the first direction through the second direction top plate mounting hole 122.

According to the above embodiments of the present disclosure, the frame assembly 1 further includes a base plate 11 and a side plate 13.

The side plate 13 is connected to one end of the top plate 12 and one end of the base plate 11 by a threaded connection mode or a riveting connection mode.

The mechanism support plate 3 is connected to the other end of the top plate 12 and the other end of the base plate 11 by a threaded connection mode or a riveting connection mode.

According to the above embodiments of the present disclosure, as illustrated by FIG. 1 and FIG. 2, the frame assembly 1 further includes a plurality of intermediate support plates 14.

The plurality of intermediate support plates 14 are spaced apart from each other along a length direction of the top plate 12 and the base plate 11 and are connected between the top plate 12 and the base plate 11 by a threaded connection mode or a riveting connection mode.

According to the above embodiments of the present disclosure, as illustrated by FIG. 1 and FIG. 2, the frame assembly 1 further includes a plurality of frame support pins 15 for further improving the rigidity of the frame assembly.

The plurality of frame support pins 15 are connected between the top plate 12 and the base plate 11 by a threaded connection mode or a riveting connection mode.

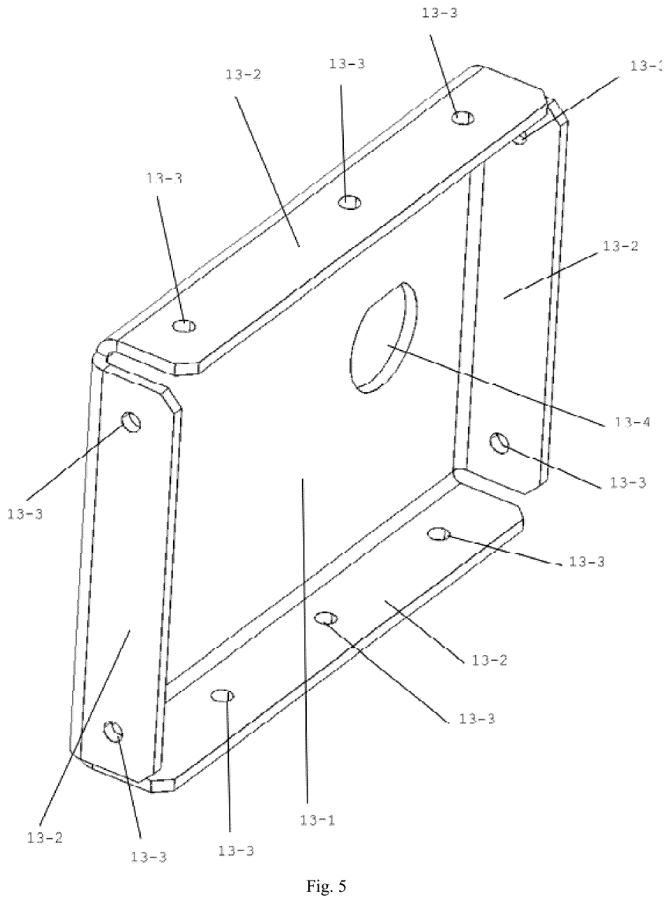

According to the above embodiments of the present disclosure, as illustrated by FIG. 5, the side plate 13 is a component made of a metal or plastic material.

The side plate 13 includes a side plate bottom 13-1 and a side plate wall 13-2 bent relative to the side plate bottom 13-1.

The side wall 13-2 is provided with a side wall mounting hole 13-3 for riveting or threaded connection.

The side plate bottom 13-1 is provided with a side plate supporting hole 13-4 for supporting the pole rotating shaft 4.

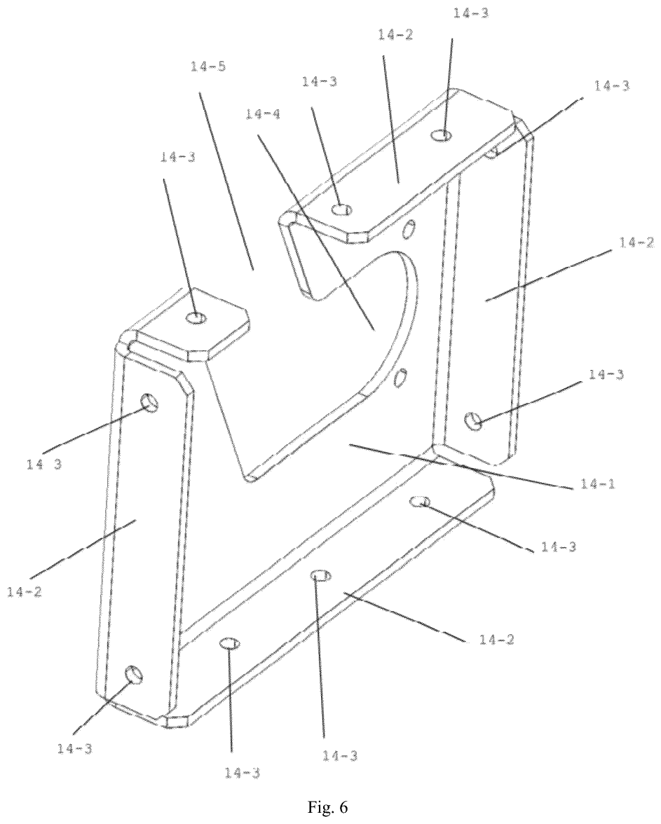

According to the above embodiments of the present disclosure, as illustrated by FIG. 6, the intermediate support plate 14 is a component made of a metal or plastic material.

The intermediate support plate 14 includes an intermediate support plate bottom 14-1 and an intermediate support plate wall 14-2 bent relative to the intermediate support plate bottom 14-1.

The intermediate support plate wall 14-2 is provided with an intermediate support plate wall mounting hole 14-3 for riveting or threaded connection.

The intermediate support plate bottom 14-1 is provided with an intermediate support plate supporting hole 14-4 for supporting the pole rotating shaft 4.

The intermediate support plate supporting hole 14-4 includes an opening 14-5 on the intermediate support plate wall 14-2. The opening 14-5 is used to mount the pole rotating shaft 4 into the intermediate support plate supporting hole 14-4.

According to the above embodiments of the present disclosure, as illustrated by FIG. 3, the top plate 12 is a sheet metal component made of a metal material.

The top plate 12 includes a top plate bottom 12-1 and a top plate wall 12-2 bent relative to the top plate bottom 12-1.

The top plate bottom 12-1 and the top plate wall 12-2 are provided with a plurality of top plate mounting holes 12-3 for riveting or threaded connection.

The top plate bottom 12-1 is provided with the plurality of top plate through holes 123, the first direction top plate mounting hole 121 and the second direction top plate mounting hole 122.

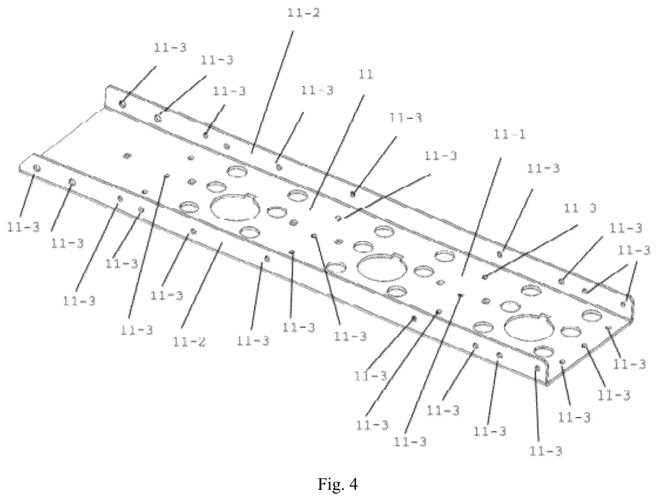

According to the above embodiments of the present disclosure, as illustrated by FIG. 4, the base plate 11 is a sheet metal component made of a metal material.

The base plate 11 includes a base plate bottom 11-1 and a base plate wall 11-2 bent relative to the base plate bottom 11-1.

The base plate bottom 11-1 and the base plate wall 11-2 are provided with a plurality of base plate mounting holes 11-3 for riveting or threaded connection.

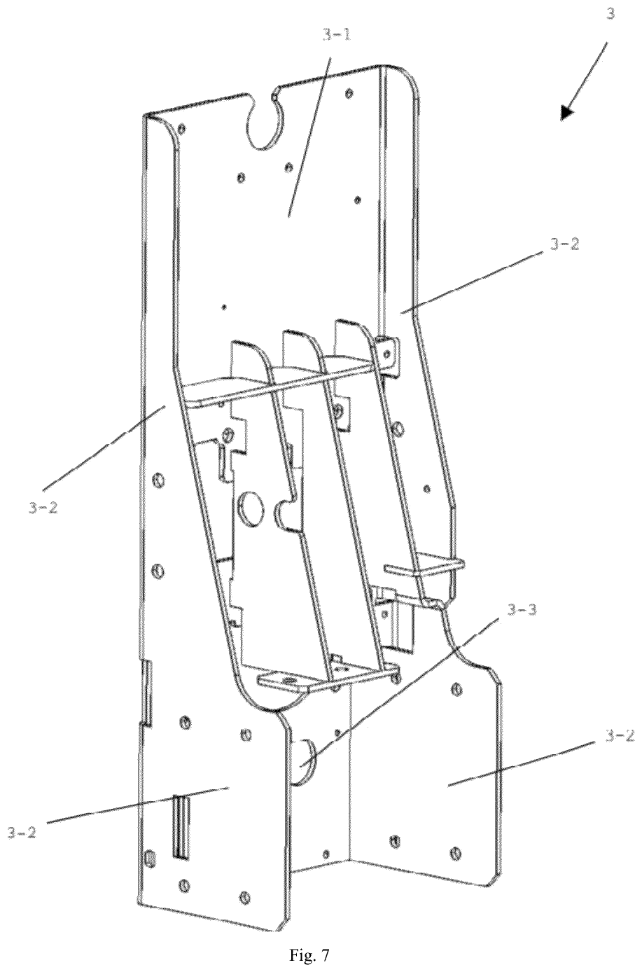

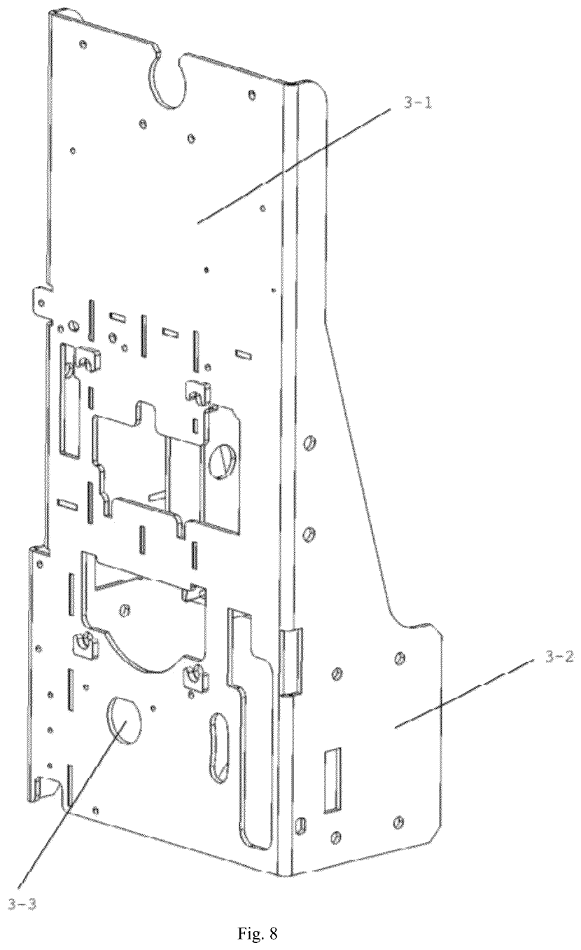

According to the above embodiments of the present disclosure, as illustrated by FIGS. 7 and 8, the mechanism support plate 3 is a sheet metal component made of a metal material.

The mechanism support plate 3 includes a support plate bottom 3-1 and a support plate wall 3-2 bent relative to the support plate bottom 3-1.

The support plate wall 3-2 is respectively connected to the base plate wall 11-2 and the top plate wall 12-2 by a threaded connection mode or a riveting connection mode.

The support plate bottom 3-1 is provided with a support plate supporting hole 3-3 for supporting the pole rotating shaft 4.

According to the above embodiments of the present disclosure, the side plate wall 13-2 is respectively connected to the top plate bottom 12-1, the top plate wall 12-2, the base plate bottom 11-1 and the base plate wall 11-2.

The intermediate support plate wall 14-2 is respectively connected to the top plate bottom 12-1, the top plate wall 12-2, the base plate bottom 11-1 and the base plate wall 11-2.

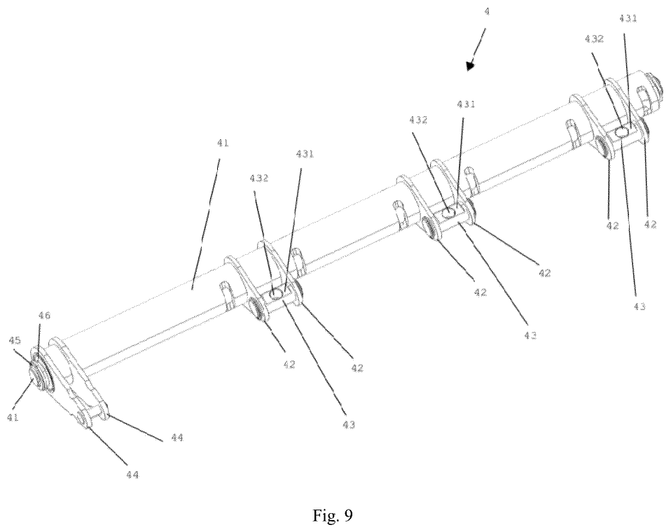

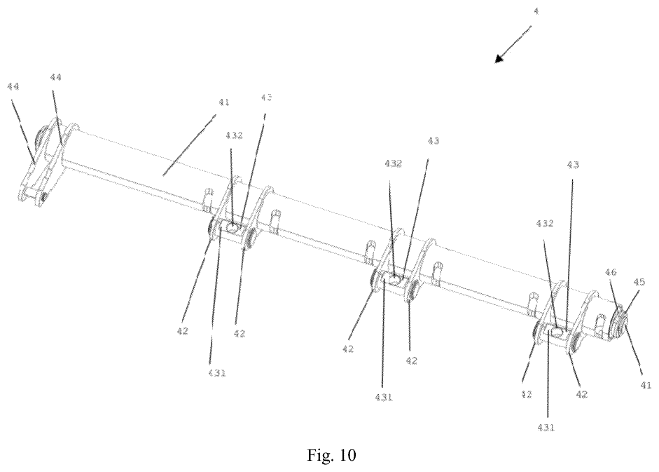

According to the above embodiments of the present disclosure, as illustrated by FIGS. 9 and 10, the pole rotating shaft 4 includes a pole rotating shaft body 41, a plurality of pole rotating shaft crank arms 42, a spring support block 43 arranged on a corresponding pole rotating shaft drive crank arm 42, and a pole rotating shaft driving crank arm 44.

The plurality of pole rotating shaft crank arms 42 are arranged on the pole rotating shaft body 41 at equal intervals along a length direction of the pole rotating shaft body 41 and arranged in one-to-one correspondence with the plurality of pole assemblies 2.

The pole rotating shaft driving crank arm 44 is arranged at one end of the pole rotating shaft body 41.

One end of the pole rotating shaft body 41 is capable of being rotatably fitted in the support plate supporting hole 3-3, for example, through a sleeve 46 and a sleeve snap ring 45, the sleeve 46 is fitted in the support plate supporting hole 3-3, and one end of the pole rotating shaft body 41 is capable of being rotatably fitted in the sleeve 46, and the sleeve snap ring 45 (which is fitted in the clamping groove of the pole rotating shaft body 41) holds the sleeve 46.

The other end of the pole rotating shaft body 41 is capable of being rotatably fitted in the side plate supporting hole 13-4, for example, through a sleeve 46 and a sleeve snap ring 45, the sleeve 46 is fitted in the side plate supporting hole 13-4, and the other end of the pole rotating shaft body 41 is rotatably fitted in the sleeve 46, and the sleeve snap ring 45 (which is fitted in the clamping groove of the pole rotating shaft body 41) holds the sleeve 46.

The spring support block 43 is provided with a spring support block plane 431 and a spring support block through hole 432.

The spring support block through hole 432 penetrates through the spring support block 43 and through the spring support block plane 431.

According to the above embodiments of the present disclosure, the pole rotating shaft body 41 is an elongated solid cylinder or an elongated tubular cylinder.

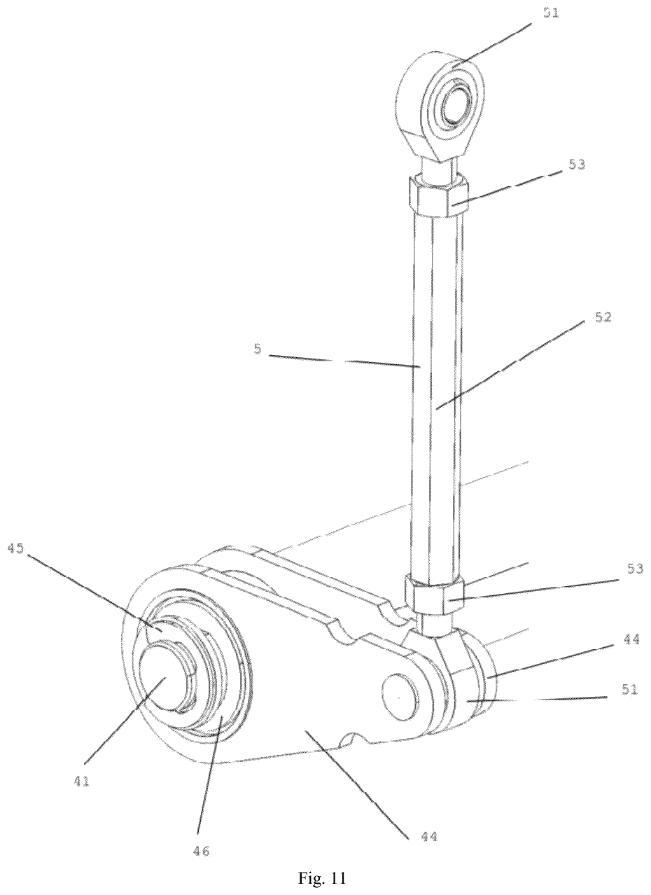

According to the above embodiments of the present disclosure, as illustrated by FIG. 11, the ball joint link 5 includes two ball joints 51, a threaded connecting rod 52 and a fastening screw 53.

The ball joints 51 are respectively connected to two ends of the threaded connecting rod 52 through threads and fastened in place through the fastening screw 53.

As illustrated by FIG. 11, the pole rotating shaft driving crank arm 44 is connected to one of the ball joints 51 through a connection pin.

As illustrated by FIG. 12, the mechanism main shaft 6 is connected to the other one of the ball joints 51 through a connection pin (not shown).

The axis of the connection pin fitted in one of the ball joints 51 is perpendicular to the axis of the connection pin fitted in the other one of the ball joints 51.

According to the above embodiments of the present disclosure, as illustrated by FIG. 12, the mechanism main shaft 6 includes a mechanism main shaft body 61 and a mechanism main shaft crank arm 62 arranged on the mechanism main shaft body 61.

The mechanism main shaft crank arm 62 is connected to the other one of the ball joints 51 through a connection pin (not shown).

A mechanism main shaft crank arm return spring 63 (see FIG. 1) is also arranged between the mechanism main shaft crank arm 62 and the frame assembly 1.

Two ends of the mechanism main shaft body 61 are capable of being rotatably connected to the support plate connection piece 3-4 arranged on the support plate wall 3-2, for example, through the sleeve and sleeve snap ring as described above.

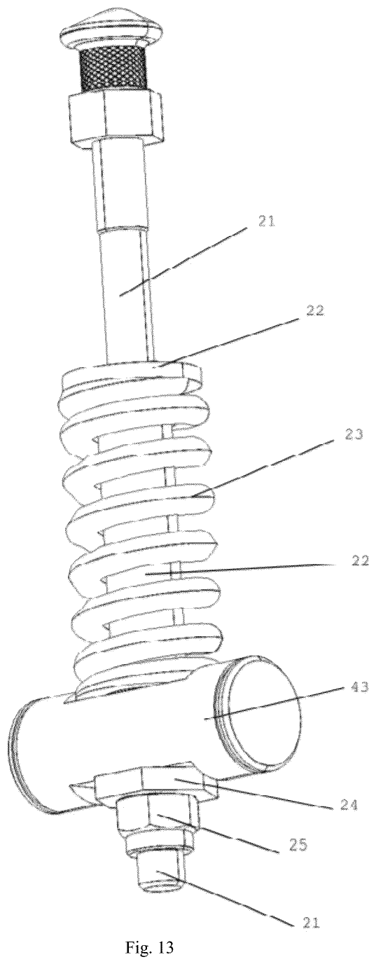

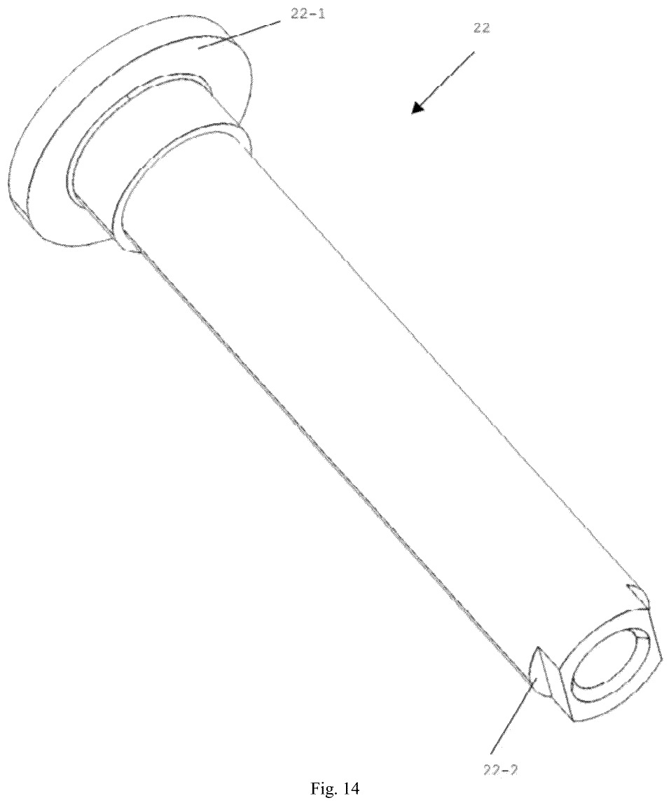

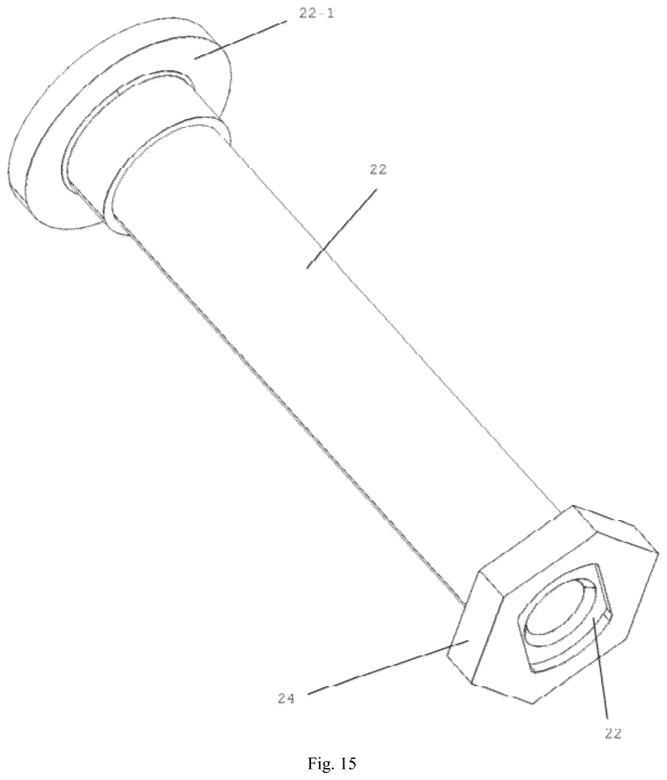

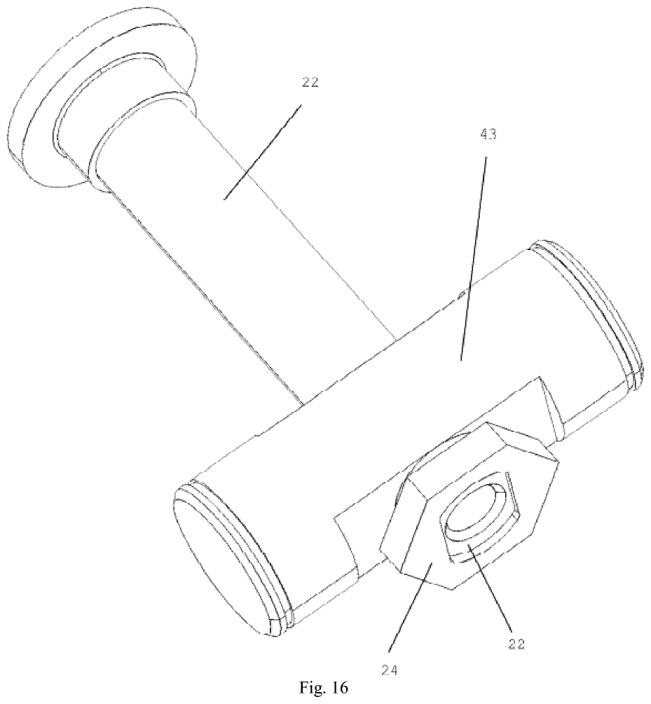

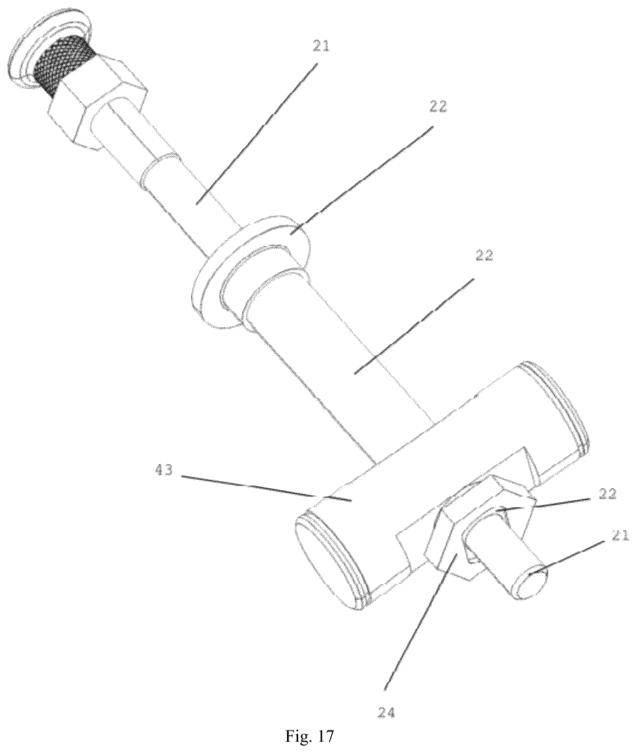

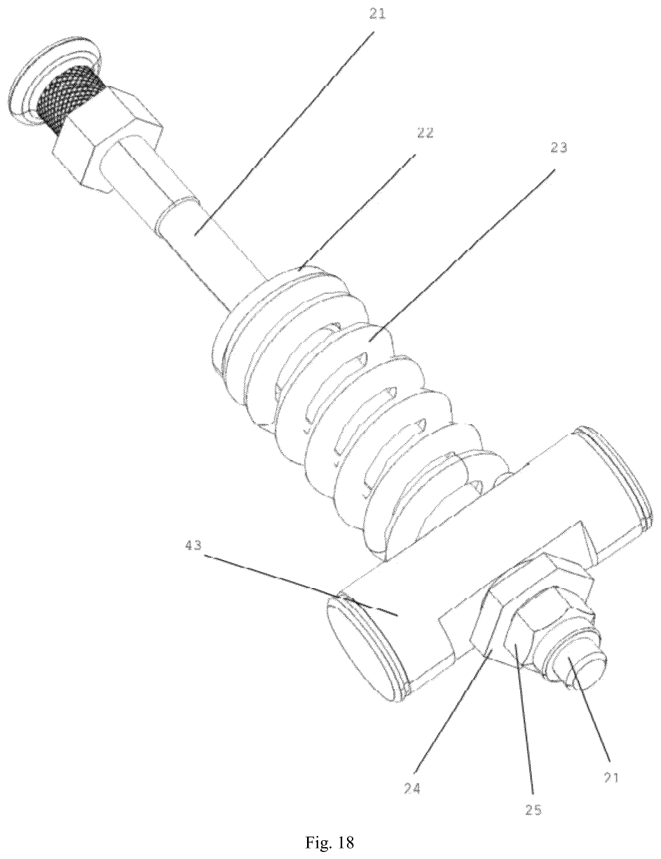

According to the above embodiments of the present disclosure, as illustrated by FIGS. 13 to 18, the pole actuating assembly 7 includes a threaded pin 21, a sleeve 22, a contact spring 23, an adjusting nut 24 and a fastening screw 25.

One end of the threaded pin 21 passes through the spring support block through hole 432.

The other end of the threaded pin 21 passes through a corresponding one of the top plate through holes 123 and enters the interior of the pole assembly 2 and acts on the pole assembly.

One end of the sleeve 22 passes through the spring support block through hole 432.

The sleeve 22 is sleeved on the threaded pin 21 and is capable of being adjusted to move along the threaded pin 21 through the threaded fit between them.

One end of the contact spring 23 abuts against the sleeve flange 22-1 of the sleeve 22.

The sleeve flange 22-1 is capable of passing through a corresponding one of the plurality of top plate through holes 123.

The other end of the contact spring 23 abuts against the spring support block plane 431 of the spring support block 43.

The adjusting nut 24 is fitted on one end of the sleeve 22 and abuts against the spring support block 43, and a position of the sleeve 22 is capable of being adjusted through the adjusting nut 24, thus achieving the adjustment of the contact stroke.

A sleeve shoulder 22-2 is arranged on one end of the sleeve 22, and the movement of the adjusting nut 24 on one end of the sleeve 22 is limited by the sleeve shoulder 22-2.

The fastening screw 25 is fitted on one end of the threaded pin 21 by screw threads and is capable of abutting against the adjusting nut 24, and the fastening screw 25 is tightened to fix the adjusting nut 24.

According to the above embodiments of the present disclosure, upon the transverse vacuum circuit breaker being in the disconnection state (as illustrated by FIGS. 1 and 19), a trigger mechanism (not shown) of the transverse vacuum circuit breaker drives the mechanism main shaft 6 to rotate from the first position to the second position, and the mechanism main shaft crank arm 62 of the mechanism main shaft 6 drives the ball joint connecting rod 5 to move through the connection pin. The movement of the ball joint connecting rod 5 drives the pole rotating shaft crank arm 42 of the pole rotating shaft 4 to rotate through the connection pin and the pole rotating shaft driving crank arm 44, and the rotation of the pole rotating shaft crank arm 42 allows the spring support block 43 to press the contact spring 23 to move upward, and the upward movement of the contact spring 23 drives the sleeve 22 to move through the sleeve flange 22-1 acting on the sleeve 22. The movement of the sleeve 22 drives the threaded pin 21 to move in the pole assembly 2, and the movement of the threaded pin 21 acts on the pole assembly 2, so that the transverse vacuum circuit breaker is in the closed state (as illustrated by FIGS. 2 and 20).

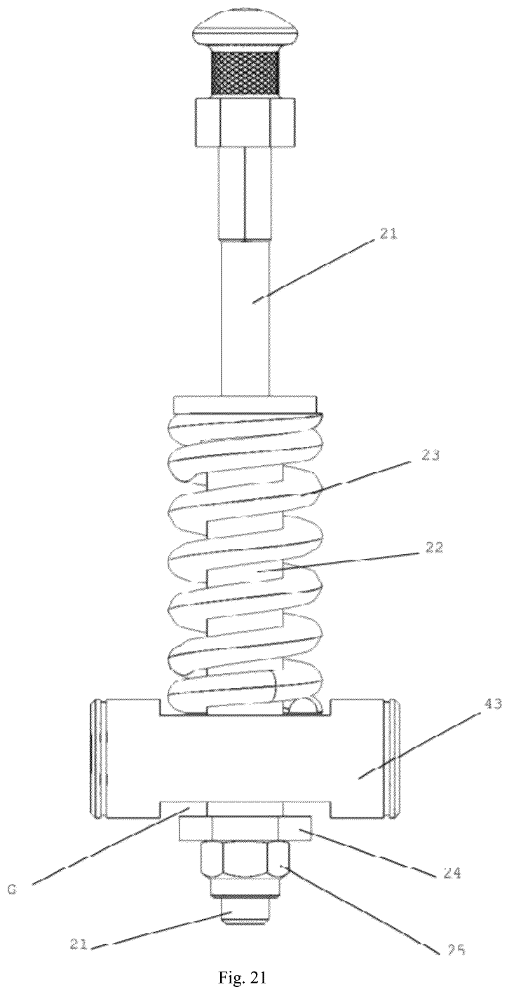

In the closed state, as illustrated by FIG. 21, a gap G exists between the adjusting nut 24 and the spring support block 43, and the gap G can be observed through the space between the top plate 12 and the base plate 11, thus achieving a visual stroke and an overtravel monitoring structure.

The transverse vacuum circuit breaker according to the present disclosure has a frame assembly 1 with simple design, in which the top plate 12, the base plate 11, the side plates 13 and the intermediate support plate 14 are all formed by sheet metal components and connected together by a riveting connection mode or a threaded connection mode, thereby avoiding the defect that the whole frame connected by welding is easy to deform and reducing the assembly time.

By providing the top plate 12 with a first direction top plate mounting hole and a second direction top plate mounting hole corresponding to each of the plurality of top plate through holes, the pole assembly 2 is capable of being mounted on the top plate 12 in a first direction through the first direction top plate mounting hole and in a second direction opposite to the first direction through the second direction top plate mounting hole, thus achieving a flexible pole assembly mounting direction.

The transverse vacuum circuit breaker according to the present disclosure connects the pole rotating shaft 4 and the mechanism main shaft 6 together through the ball joint connecting rod 6 to form a new type and simple connecting rod mechanism, thereby reducing the moving components as much as possible, and further reducing the cost and the assembly time. Because the push/pull motion system is avoided to achieve the closing and opening operations of the transverse vacuum circuit breaker, the transverse vacuum circuit breaker according to the present disclosure can achieve the stable synchronization of the pole assemblies.

The foregoing disclosure provides illustration and description, but is not intended to be exhaustive or to limit the embodiments to the precise forms disclosed. Modifications and variations are possible in light of the above disclosure, or may be acquired from practice of the embodiments.

Even if specific combinations of features are recited in the claims and/or disclosed in the specification, these combinations are not intended to limit the present disclosure of various embodiments. In fact, many of these features can be combined in ways not specifically recited in the claims and/or not specifically disclosed in the specification. Although each dependent claim listed below may directly depend on only one claim, the present disclosure of various embodiments includes each dependent claim in combination with every other claim in the claim set.

1. A transverse vacuum circuit breaker, wherein the transverse vacuum circuit breaker comprises a frame assembly, a pole assembly, a mechanism support plate, a mechanism main shaft, a ball joint connecting rod, a pole rotating shaft and a pole actuating assembly;
the mechanism support plate is connected to the frame assembly and the mechanism main shaft is capable of being rotatably mounted on the mechanism support plate;
a plurality of pole assemblies are mounted on the frame assembly, and the pole rotating shaft is capable of being rotatably mounted inside the frame assembly;
one end of the pole actuating assembly is connected to the pole rotating shaft;
the other end of the pole actuating assembly acts on the pole assembly;
the ball joint connecting rod is connected between the mechanism main shaft and the pole rotating shaft;
the mechanism main shaft is capable of rotating between a first position and a second position, and a rotation of the mechanism main shaft is capable of driving a rotation of the pole rotating shaft through the ball joint connecting rod, and the rotation of the pole rotating shaft drives a movement of the pole actuating assembly;
upon the mechanism main shaft rotating to the first position, the pole actuating assembly allows the plurality of pole assemblies in a disconnected state;
upon the mechanism main shaft rotating to the second position, the pole actuating assembly allows the plurality of pole assemblies in a closed state.

2. The transverse vacuum circuit breaker according to claim 1, wherein,
the frame assembly comprises a top plate;
the top plate is provided with a plurality of top plate through holes spaced at equal intervals from each other along a length direction of the top plate;
the top plate is provided with a first direction top plate mounting hole and a second direction top plate mounting hole corresponding to each of the plurality of top plate through holes;
the pole assembly is capable of being mounted on the top plate in a first direction through the first direction top plate mounting hole;
the pole assembly is capable of being mounted on the top plate in a second direction opposite to the first direction through the second direction top plate mounting hole.

3. The transverse vacuum circuit breaker according to claim 2, wherein,
the frame assembly further comprises a base plate and a side plate;
the side plate is connected to one end of the top plate and one end of the base plate through a threaded connection mode or a riveting connection mode;
the mechanism support plate is connected to the other end of the top plate and the other end of the base plate through a threaded connection mode or a riveting connection mode.

4. The transverse vacuum circuit breaker according to claim 3, wherein,
the frame assembly further comprises a plurality of intermediate support plates;
the plurality of intermediate support plates are spaced apart from each other along a length direction of the top plate and the base plate and are connected between the top plate and the base plate by a threaded connection mode or a riveting connection mode.

5. The transverse vacuum circuit breaker according to claim 4, wherein,
the frame assembly further comprises a plurality of frame support pins;
the plurality of frame support pins are connected between the top plate and the base plate through a threaded connection mode or a riveting connection mode.

6. The transverse vacuum circuit breaker according to claim 4, wherein,
the side plate is a component made of a metal or plastic material;
the side plate comprises a side plate bottom and a side plate wall bent relative to the side plate bottom;
the side plate wall is provided with a side plate wall mounting hole for riveting or threaded connection;
the side plate bottom is provided with a side plate supporting hole for supporting the pole rotating shaft.

7. The transverse vacuum circuit breaker according to claim 6, wherein,
each of the plurality of intermediate support plates is a component made of a metal or plastic material;
each of the plurality of intermediate support plates comprises an intermediate support plate bottom and an intermediate support plate wall bent relative to the intermediate support plate bottom;
each of the plurality of intermediate support plates is provided with an intermediate support plate wall mounting hole for riveting or threaded connection;
the intermediate support plate bottom is provided with an intermediate support plate supporting hole for supporting the pole rotating shaft;
the intermediate support plate supporting hole comprises an opening on the intermediate support plate wall.

8. The transverse vacuum circuit breaker according to claim 7, wherein,
the top plate is a sheet metal component made of a metal material;
the top plate comprises a top plate bottom and a top plate wall bent relative to the top plate bottom;
the top plate bottom and the top plate wall are provided with top plate mounting holes for riveting or threaded connection;
the top plate bottom is provided with the plurality of top plate through holes, the first direction top plate mounting hole and the second direction top plate mounting hole.

9. The transverse vacuum circuit breaker according to claim 8, wherein,
the base plate is a sheet metal component made of a metal material;
the base plate comprises a base plate bottom and a base plate wall bent relative to the base plate bottom;
the base plate bottom and the base plate wall bent are provided with base plate mounting holes for riveting or threaded connection.

10. The transverse vacuum circuit breaker according to claim 9, wherein,
the mechanism support plate is a sheet metal component made of a metal material;
the mechanism support plate comprises a support plate bottom and a support plate wall bent relative to the support plate bottom;
the support plate wall is respectively connected to the base plate wall and the top plate wall through a threaded connection mode or a riveting connection mode;
the support plate bottom is provided with a support plate supporting hole for supporting the pole rotating shaft.

11. The transverse vacuum circuit breaker according to claim 9, wherein,
the side plate wall is respectively connected to the top plate bottom, the top plate wall, the base plate bottom and the base plate wall;
the intermediate support plate wall is respectively connected to the top plate bottom, the top plate wall, the base plate bottom and the base plate wall.

12. The transverse vacuum circuit breaker according to claim 10, wherein,
the pole rotating shaft comprises a pole rotating shaft body, a plurality of pole rotating shaft crank arms, a spring support block arranged on a corresponding one of the plurality of pole rotating shaft crank arms, and a pole rotating shaft driving crank arm;
the plurality of pole rotating shaft crank arms are arranged on the pole rotating shaft body at equal intervals along a length direction of the pole rotating shaft body and arranged in one-to-one correspondence with the plurality of pole assemblies;
the pole rotating shaft driving crank arm is arranged at one end of the pole rotating shaft body;
one end of the pole rotating shaft body is capable of being rotatably fitted in the support plate supporting hole;
the other end of the pole rotating shaft body is capable of being rotatably fitted in the side plate supporting hole;
the spring support block is provided with a spring support block plane and a spring support block through hole;
the spring support block through hole penetrates through the spring support block and the spring support block plane.

13. The transverse vacuum circuit breaker according to claim 12, wherein,
the pole rotating shaft body is an elongated solid cylinder or an elongated tubular cylinder.

14. The transverse vacuum circuit breaker according to claim 12, wherein,
the ball joint connecting rod comprises two ball joints, a threaded connecting rod and a fastening screw;
the ball joints are respectively connected to two ends of the threaded connecting rod through threads and fastened in place through the fastening screw;
the pole rotating shaft driving crank arm is connected to one of the ball joints through a connection pin;
the mechanism main shaft is connected to the other one of the ball joints through a connection pin;
an axis of the connection pin fitted in one of the ball joints is perpendicular to an axis of the connection pin fitted in the other one of the ball joints.

15. The transverse vacuum circuit breaker according to claim 14, wherein,
the mechanism main shaft comprises a mechanism main shaft body and a mechanism main shaft crank arm arranged on the mechanism main shaft body;
the mechanism main shaft crank arm is connected to the other one of the ball joints through a connection pin;
two ends of the mechanism main shaft body are capable of being rotatably connected to support plate connection pieces arranged on the support plate wall.

16. The transverse vacuum circuit breaker according to claim 15, wherein,
the pole actuating assembly comprises a threaded pin, a sleeve, a contact spring, an adjusting nut and a fastening screw;
one end of the threaded pin passes through the spring support block through hole;
the other end of the threaded pin passes through a corresponding one of the plurality of top plate through holes and enters an interior of the pole assembly and acts on the pole assembly;
one end of the sleeve passes through the spring support block through hole;
the sleeve is sleeved on the threaded pin and is capable of being adjusted to move along the threaded pin through threaded fit between the sleeve and the threaded pin;
one end of the contact spring abuts against a sleeve flange of the sleeve;
the sleeve flange is capable of passing through a corresponding one of the plurality of top plate through holes;
the other end of the contact spring abuts against the spring support block plane of the spring support block;
the adjusting nut is fitted on one end of the sleeve and abuts against the spring support block, and a position of the sleeve is capable of being adjusted through the adjusting nut, thus achieving an adjustment of a contact stroke;
a sleeve shoulder is arranged on one end of the sleeve, and a movement of the adjusting nut on one end of the sleeve is limited by the sleeve shoulder;
the fastening screw is fitted on one end of the threaded pin by screw threads and is capable of abutting against the adjusting nut, and the fastening screw is tightened to fix the adjusting nut.

17. The transverse vacuum circuit breaker according to claim 16, wherein,
upon the transverse vacuum circuit breaker being in the disconnection state, a trigger mechanism of the transverse vacuum circuit breaker drives the mechanism main shaft to rotate from the first position to the second position, and the mechanism main shaft crank arm of the mechanism main shaft drives the ball joint connecting rod to move through the connection pin, and a movement of the ball joint connecting rod drives the pole rotating shaft crank arm of the pole rotating shaft to rotate through the connection pin and the pole rotating shaft driving crank arm, a rotation of the pole rotating shaft crank arm allows the spring support block to press the contact spring to move upwards, and an upward movement of the contact spring drives the sleeve to move through the sleeve flange acting on the sleeve, and a movement of the sleeve drives the threaded pin to move in the pole assembly, and a movement of the threaded pin acts on the pole assembly, so that the transverse vacuum circuit breaker is in the closed state;
in the closed state, a gap exists between the adjusting nut and the spring support block, and the gap is capable of being observed through a space between the top plate and the base plate.
